(19) United States
(12) Patent Application Publication
(10) Pub. No.: US 2005/0246938 A1
(43) Pub. Date: Nov. 10, 2005

(54) Powdered animal scent composition and structures and methods for making and/or using such powdered animal scent compositions

(76) Inventor: Kurt A. Windus, Madison, WI (US)

Correspondence Address: LATHROP & CLARK LLP, 740 REGENT STREET SUITE 400, P.O. BOX 1507, MADISON, WI, 537011507, US

(21) Appl. No.: 10/842,266

(22) Filed: May 10, 2004

(51) Int. Cl. A01M 1/00

(52) U.S. Cl. 43/1

(57) ABSTRACT

An animal scent composition includes a liquid animal scent component and a carrier composition. The scent component can include animal urine, other animal glandular secretions and/or gland materials. The carrier composition can include sodium bicarbonate, calcium carbonate, magnesium carbonate, baking powder and/or cornstarch, along with silicon dioxide. The resulting mixture is dried. The dried mixture is fed into a milling device and broken into small pieces and fine powder. The resulting small pieces and fine powder are fed into a sifter, where the milled dry mixture is sifted and possibly further processed to collect a fine powdered animal scent composition. The resulting fine powdered animal scent composition is then placed into flexible bottles and capped with a cap, such that compression of the flexible bottle causes a fine aerosol or suspension of the fine powdered animal scent composition to be ejected from the flexible bottle into the surrounding atmosphere.

### BACKGROUND OF THE INVENTION

1. Field of the Invention

This invention relates to an animal scent composition in a powdered form.

2. Related Art

Raw animal scents and compositions containing animal scents are often used by hunters, wildlife management professionals, and/or wildlife enthusiasts and others who enter into areas where wild animals are present. Such animal scents and animal scent compositions are typically used to either lure a specific animal to a desired location, to mask the presence of one or more humans in the area where the wild animal(s) is present, and/or to repel one or more different animal species from a given location. For example, hunters often use raw animal scents and/or animal scent compositions in an attempt to lure one or more animals of a particular desired species to a location where the hunter is located. Such animal scent compositions and raw animal scents are also used to mask the scent of the person in an attempt to prevent the animal from discerning the presence of the person at the location to which the animal is to be lured or intercepted.

For many years, raw animal scents and animal scent compositions were limited to raw animal urine, raw urine mixed with other secretions by that animal, and compositions comprising raw urine, with or without other secretions, and various preservatives and other materials designed to extend the shelf life and strength of scent in the animal scent composition. However, such liquid forms of raw animal scent and animal scent compositions are bulky to handle, heavy, prone to spillage, and have only limited shelf life at best.

Recently, other forms of raw animal scent and animal scent compositions have been proposed. For example, U.S. Pat. No. 5,896,692 to Collora, et al. discloses a freeze-dried form of raw and preferably unadulterated animal urine which can be used as a scent lure for hunting. Other forms of the freeze-dried scent include animal urine combined with glands and/or glandular secretions of the animal. These glands and/or glandular secretions are blended with the urine prior to freeze drying the blended material. However, the material disclosed in the '692 patent specifically excludes preservatives and other non-animal products from the freeze-dried raw animal scent. In contrast, U.S. Pat. No. 6,149,901 to Weiser discloses an animal scent composition comprising an animal scent, such as urine and/or manure, in either liquid or freeze-dried form, in combination with calcium carbonate, magnesium carbonate, and crystalline silica, and possibly with sodium chloride.

### SUMMARY OF DISCLOSED EMBODIMENTS

The “901 patent provides no teaching for how the disclosed compositions of matter are to be manufactured, nor does it provide any disclosure for the form in which the composition of matter exists in its usable state. The '692 application suggests that the disclosed freeze-drying process for freeze-drying the raw animal scent product inherently results in a powdered urine product. However, the '692 patent provides no teaching or disclosure for the form of the asserted powdered urine product. Moreover, the '901 patent provides no teaching disclosure or suggestion for how the disclosed animal scent compositions are to be used. The '692 patent also provides only limited disclosure for how the freeze-dried raw animal scent product is to be used.

This invention provides an improved animal scent composition.

This invention separately provides an animal scent composition that can be ejected into the environment as an aerosol and/or suspension from a container containing the animal scent composition.

This invention separately provides an animal scent composition having a longer shelf life than liquid raw animal scents and/or liquid animal scent compositions.

This invention separately provides an animal scent composition having improved scent releasing capabilities relative to known liquid, freeze-dried and/or powdered raw animal scents and/or animal scent compositions.

This invention separately provides an animal scent composition that is capable of reactivating in the presence of moisture and/or solar heat.

This invention separately provides a powdered animal scent composition that will remain in suspension in the atmosphere at typical earth surface temperatures, pressures and humidities.

This invention separately provides structures and methods for making a fine powdered animal scent composition.

This invention separately provides structures and methods for using a finely powdered animal scent composition.

This invention separately provides structures and methods for creating an aerosol or suspension of finely powdered animal scent composition.

In various exemplary embodiments of an animal scent composition according to this invention, such an animal scent composition includes a first part comprising a raw animal scent composition in liquid form and a second part comprising a carrier composition. In various exemplary embodiments of an animal scent composition according to this invention, the first and second parts are combined to form an aerosolizable powder. In various exemplary embodiments of an animal scent composition according to this invention, the first and second parts are combined in a desired ratio of about 1 to about 3, respectively. In various exemplary embodiments, the animal scent composition includes animal urine, but can include other animal glandular secretions and/or gland materials in place of or in addition to the animal urine. In various exemplary embodiments, the animal urine is deer urine, which can include buck and/or doe urine. In various exemplary embodiments, the carrier composition includes one or more of sodium bicarbonate, calcium carbonate, magnesium carbonate, baking powder and/or cornstarch, along with silicon dioxide or similar anti-clumping agent.

In various exemplary embodiments, the animal scent composition is manufactured by first combining the one or more materials forming the second part in desired proportions, while combining the one or more animal scent materials forming the first part in various desired proportions. Then, the first and second parts are combined in ratios from about 80% to 20% respectively, to about 70% to 30%, respectively, and desirably at a ratio of about 1 part to about 3 parts, respectively. The resulting mixture is then dried. In various exemplary embodiments, the mixture is dried by placing it into one or more trays and placing the trays in a dryer. In various other exemplary embodiments, continuous dryers, such as fluidized bed dryers, or other appropriate dryers, are used to dry the mixture. The dried mixture is then fed into a milling device, such as a hammer mill, and broken into small pieces and fine powder. The resulting small pieces and fine powder are fed into a sifter/screener, where the milled dry mixture is sifted and further processed to ensure a fine powdered animal scent composition is collected. The resulting fine powdered animal scent composition is then packaged for use.

In various exemplary embodiments, the fine powdered animal scent composition is placed into flexible bottles and capped with a cap having an ejection nozzle, such that, when the cap is opened, compression of the flexible bottle causes a fine aerosol or suspension of the fine powdered animal scent composition to be ejected from the flexible bottle through the nozzle and into the surrounding atmosphere. In various other exemplary embodiments, the fine powdered animal scent product is placed into an aerosol can or the equivalent, along with sufficient appropriate propellant, such that, when the propellant is released from the aerosol can, the propellant carries the fine powder animal scent composition with it to form a suspension or aerosol in the surrounding atmosphere.

These and other features and advantages of various exemplary embodiments of the compositions, structures and methods according to this invention are described in, or are apparent from, the following detailed descriptions of various exemplary embodiments of the compositions, structures and methods according to this invention.

### BRIEF DESCRIPTION OF DRAWINGS

Various exemplary embodiments of the compositions, structures and methods according to this invention will be described in detail, with reference to the following figures, wherein:

FIG. 1 is a flowchart outlining one exemplary embodiment of a method for manufacturing a fine powdered animal scent composition according to this invention;

FIG. 2 is a block diagram of a system for manufacturing a fine powdered animal scent composition according to this invention;

FIG. 3 illustrates one exemplary embodiment of a container and a cap usable to generate a suspension or aerosol of a fine powdered animal scent composition according to this invention;

FIG. 4 illustrates various exemplary embodiments of other cap structures usable with the container shown in FIG. 3 to generate a suspension or aerosol of a fine powdered animal scent composition according to this invention; and

FIG. 5 is a flowchart outlining one exemplary embodiment of a method for generating an aerosol or suspension of fine powdered animal scent composition according to this invention.

### DETAILED DESCRIPTION OF EXEMPLARY EMBODIMENTS

When interacting with wild animals in their native environments, whether in an attempt to hunt such animals, photograph such animals, or interact with such animals for wildlife management purposes, such as tagging, physical examination, sample collection, and/or providing veterinary services, it is often desirable to lure the wild animal to a desired location, or intercept the wild animal in its natural environment, rather than actively search for the wild animal. Similarly, because many wild animals associate human scent with danger or avoidance, it is often desirable for people attempting to interact with wildlife to mask their human scent with a stronger animal-neutral or animal-attractive scent. Additionally, it is often desirable to repel animals from a specific location.

For example, when interacting with wild deer populations, either for hunting or for wildlife management purposes, such as population surveys or surveys regarding Chronic Wasting Disease (CWD), it is often more efficient to lure the deer to a desired location, rather than attempting to actively track the deer.

Traditionally, the materials used to lure wildlife to desired locations, to mask the presence of humans, and to repel animals from specific locations have been based on liquids containing animal urine and/or glandular secretions and/or glandular material of the animal to be lured to the specific location. Types of animal urines and/or other glandular secretions or materials used in such materials include those from fox, coyote, deer, elk, moose, bear, rabbit, and the like, although it should be understood that this list is neither exhaustive nor limiting. Other animal products that can be used in such lures can include fish oils and excrement, such as sheep manure.

As disclosed in the '692 patent, such liquid-based formulations have a number of disadvantages, including their bulk, difficulty of use, and poor shelf life. Additionally, as can be readily appreciated, such liquid formulations can be difficult to disburse in the wildlife environment, are messy and inconvenient to use, and, when placed on the ground, are likely to be quickly absorbed and/or evaporated, such that the effectiveness of the liquid formulation quickly deteriorates. The '692 patent discloses a method for freeze-drying liquid animal urine which results in a pure or unadulterated powdered animal urine product. However, the freeze-drying process can significantly negatively affect the ability of the freeze-dried composition to release aroma molecules into the ambient environment. The aroma compounds in freeze-dried animal scent compositions are very sensitive to chemicals present in tap water, such as chlorine, or in dew, such as acids. Thus, unless distilled water is used to reactivate such freeze-dried animal scent compositions, the effectiveness and longevity of such freeze-dried animal scent composition is significantly reduced. Freeze-drying is also expensive and is generally limited to compositions where the major constituent is a liquid at standard temperatures and pressures.

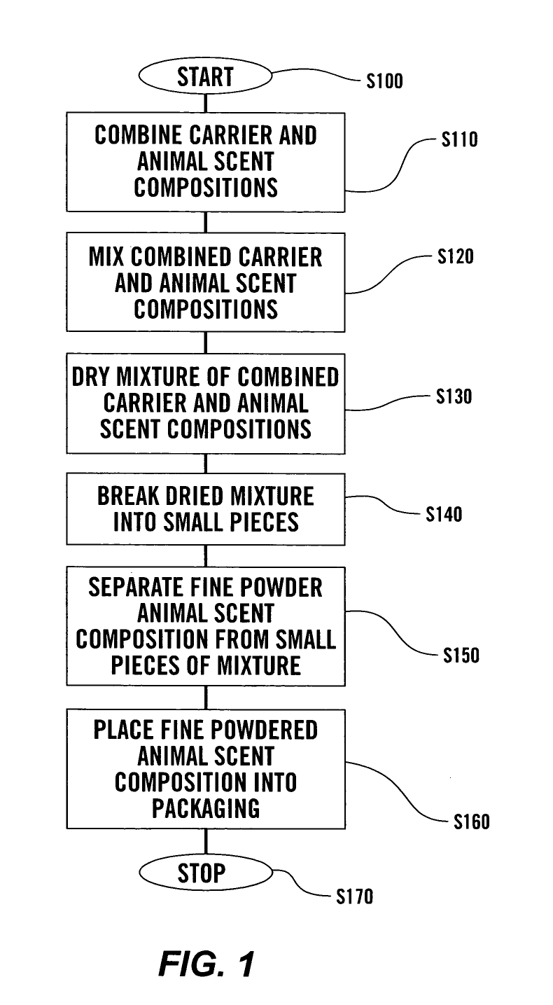

FIG. 1 is a flowchart outlining one exemplary embodiment of a method for producing an improved animal scent composition, or more generally, a sporting scent, that can be disbursed as a fine aerosol or suspension and that has excellent scent-releasing capabilities, scent strength and/or appropriate scent-releasing time frames. As shown in FIG. 1, beginning in step S100, operation of the method continues to step S110, where a carrier composition and an animal scent composition are combined to create a combined carrier and scent composition. The animal scent composition is a liquid, and, in various exemplary embodiments, includes animal urine, animal glandular secretions, animal glandular material and/or any other appropriate animal scent material. Exemplary embodiments of a liquid animal scent composition are the liquid deer buck and/or doe urine animal scent compositions sold by Doc's Deer Farm and Scents of Cortland, Ohio. However, it should be appreciated that any other commercially available or other appropriate liquid animal scent composition could be used. In particular, the appropriate liquid animal scent composition can include any liquid animal scent composition that is usable to attract or repel, or mask the presence of humans to, any animal that is responsive to its sense of smell.

In various exemplary embodiments, the carrier composition comprises about 95% to about 99% by weight sodium bicarbonate and about 1% to about 5% by weight silicon dioxide. However, it should be appreciated that various other carrier materials and minerals, such as calcium carbonate, magnesium carbonate, baking powder, cornstarch and the like could be used in place of some or all of the sodium bicarbonate. Similarly, any other appropriate anti-clumping agent can be used in place of or in addition to the silicon dioxide. Sodium bicarbonate is a desirable constituent of the carrier composition due to its inherent preservative qualities. In general, any material which can be saturated with the liquid animal scent composition can be used in the carrier composition. In various exemplary embodiments, the carrier composition includes about 30% to about 99% sodium bicarbonate, about 0% to about 69% calcium carbonate, about 0% to about 69% magnesium carbonate, about 0% to about 69% baking powder, about 0% to about 69% cornstarch and about 1% to about 5% silicon dioxide and/or other anti-clumping agent.

In general, the carrier composition and the liquid animal scent composition are combined such that there is at least enough liquid animal scent composition to wet all of the carrier composition. However, once the carrier composition is saturated with the liquid animal scent composition, any additional animal scent composition is wasted, as that additional liquid animal scent composition will be evaporated and destroyed in the drying process. In various exemplary embodiments, a mixture of about 20% liquid animal scent composition to about 80% carrier composition is sufficient to wet all of the carrier composition. In various other exemplary embodiments, about 28% to about 30% liquid animal scent composition to about 70% to about 72% carrier composition is sufficient to saturate the carrier composition with the liquid animal scent composition without wasting non-trivial amounts of the liquid animal scent composition. In various exemplary embodiments, the carrier composition is desirably combined with the liquid animal scent composition at a desirable ratio of about three parts carrier composition to about one part liquid animal scent composition.

Next, in step S120, the combined carrier and animal scent compositions are thoroughly mixed to generally evenly disburse the liquid animal scent composition into the carrier composition. In various exemplary embodiments, the liquid animal scent composition will generally wet to saturate the carrier composition, forming a paste, a soft and plastic mass, or the like. In various exemplary embodiments, the combined carrier and animal scent compositions are mixed, for example, for sufficient time to create a generally uniform or undifferentiated mixture.

Next, in step S130, the mixture of the carrier and animal scent compositions is dried to remove any water or other liquid phase portions of the mixture. In various exemplary embodiments, the mixture resulting from step S300 is placed into drying trays. In various exemplary embodiments, the drying trays are about 1 inch to about 2 inches deep. In various exemplary embodiments, the mixture can be dried in a batch dryer, such as a batch tray dryer. In various exemplary embodiments, the mixture is dried in an environment that is heated to a temperature between about 140° F. and about 210° F., inclusive, and more desirably between about 160° F. and about 200° F., inclusive. It should be appreciated that, to reduce the detrimental effects of drying on the liquid animal scent composition, the temperature of the dryer environmental is desirably kept below the boiling point of water at the environmental pressure within the dryer.

It should also be appreciated that other types of batch or continuous feed dryers, beyond the tray-based dryer described above, can be used to dry the mixture of animal scent and carrier composition. For example, a fluidized bed dryer that allows the mixture of animal scent and carrier compositions to be continuously fed through the fluidized bed dryer and dried can be used in place of the tray-based dryer. It should be appreciated that such other dryers may operate over different temperature ranges than those described above. However, in such dryers, the temperature is still desirably kept below the boiling point of water.

In various exemplary embodiments, when using a tray-based dryer, the mixture is dried for about 1 hour to about 2 hours, and desirably about 1.5 hours. The mixture is then removed from the dryer and broken up in the trays. It should be appreciated that this allows the mixture to dry more quickly and/or more evenly. The mixture can be broken into pieces that are, for example, on the order of about 1 inch to about 2 inches on a side. The mixture pieces are then returned to the tray-based dryer and dried for an additional time of about 2 hours to about 4 hours. Operation then continues to step S140.

In step S140, the dried mixture is broken up into a rough powder or the like. In various exemplary embodiments, the rough powder is on the order of the form of the powder used to form the initial carrier composition. In various exemplary embodiments, the rough powder will contain a significant proportion of milled mixture that is dust-like or approaching finished product dimensions, with the rest of the rough powder present as larger pieces. In various exemplary embodiments, the dried mixture is feed into a Buffalo® hammer mill, which breaks the dried mixture into a combination of dust-like particles and larger pebble-like pieces. It should be appreciated that any mill device or any other device which is usable to break the dried mixture into small pieces can be used in place of the Buffalo® hammer mill. In various exemplary embodiments, the hammer mill or like mills the dried mixture for approximately 5 minutes to approximately 10 minutes to break up the dry mixture into a rough powder form. In general, the rough powder will range in size from dust to small pebbles.

Next, in step S150, the broken-up dried mixture output from the hammer mill or the like is transported by, for example, a vibrating feeder, into a sifter or other device that separates fine particles of the dried mixture from any larger pieces. In various exemplary embodiments, the sifter can also further refine the pieces received from the hammer mill or the like by breaking down the larger pieces of the dried mixture into the fine dust suitable for use as a fine powdered scent composition according to this invention. One exemplary embodiment of such a sifter is a Midwestern® porta sifter/screener that uses a single 100 mesh screen. In various other exemplary embodiments, the pieces which are too large fit through the sifter/screener are returned to the hammer mill for further processing. It should be appreciated that the fine powdered mixture separated by the sifter can be collected into any desired collection device or drum.

It should also be appreciated that the drying process itself may result in a dried mixture that is already in powder or near-powdered form. For example, a continuous drying process, such as that performed by a fluidized bed dryer, a spray dryer or the like, may result on a dried mixture that is in, or is close to, powder form. In this case, it may be possible to omit the milling process performed in step S140, such that operation of the process jumps directly from step S130 to Step 150.

Then, in step S160, the fine powdered animal scent composition obtained from the sifter and stored in the collection device is placed into a suitable package. It should be appreciated that suitable packaging includes flexible bottles or other containers and the like and appropriate nozzles, caps or the like that allow the fine powdered animal scent composition to be ejected from the container as a fine aerosol or suspension into the wildlife environment. Various exemplary embodiments of suitable caps for the container include disk-style flip top caps, sifter caps, powder spice caps with a sifter-style insert, twist-to-open caps, spout caps, push-pull caps, spice caps with integral sifter openings and flapper, shaker orifice inserts and the like.

It should be appreciated that the cap typically both caps or seals the fine powdered animal scent compositions in the containers when in a closed state and provides one or more openings through which the fine powdered animal scent composition can be ejected from the container to form the aerosol or suspension. In various exemplary embodiments, the opening is a nozzle or the like, such that, when the flexible container is compressed, a stream of air is forced through the opening(s) in the cap. In general, this stream of air will contain a not-insignificant quantity of the fine powdered animal scent composition, which then mixes with the ambient atmosphere to form the aerosol or suspension.

It should further be appreciated that the opening(s) need not necessarily be formed in the cap, but can be provided in other portions of the container. Additionally, the opening(s) need not necessarily be narrow, or nozzle-like, so long as an aerosol or suspension of the fine powdered animal scent composition can be formed when air is forced from the flexible container through the opening. It should be appreciated that any appropriate cap having a nozzle or other opening that allows the fine powdered animal scent to be ejected from the packaging element as, or to form, an aerosol or suspension can be used with any appropriately flexible bottle, container or other packaging element.

It should also be appreciated that the container need not necessarily be flexible, if some other mechanism is provided for forcing a stream of gas containing the fine powdered animal scent composition through the opening(s). In various exemplary embodiments, the fine powdered animal scent composition obtained from the sifter/screen can be placed into aerosol cans or the like, along with an appropriate propellant. It should be appreciated that any propellant, such as CO2, that is compatible with the fine powdered animal scent composition can be used in such aerosol cans to propel the fine powdered animal scent composition from the aerosol can into the ambient environment as an aerosol or suspension.

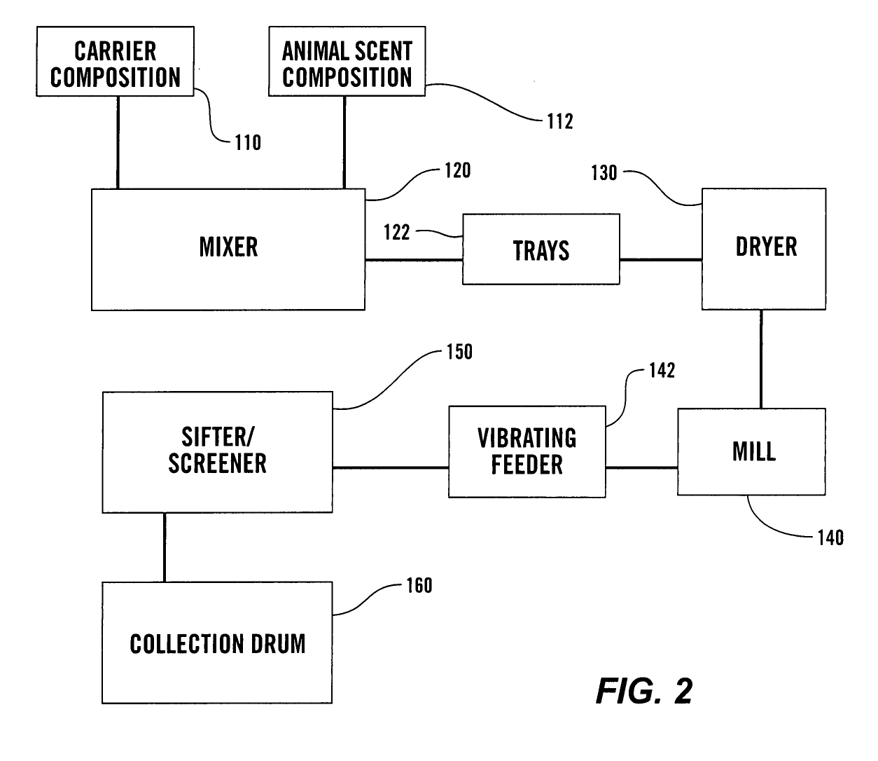

FIG. 2 is a block diagram outlining one exemplary embodiment of a system 100 for manufacturing the fine powdered animal scent composition according to this invention. As shown in FIG. 2, the manufacturing system 100 includes a first element 110 that contains the carrier composition and a second element 112 that contains the liquid animal scent composition.

As set forth above, in various exemplary embodiments, the carrier composition includes about 95% to about 99% by weight sodium bicarbonate and/or the like and about 1% to about 5% by weight silicon dioxide and/or other anti-clumping. However, as outlined above, the carrier composition can include, in place of or in addition to the sodium bicarbonate, calcium carbonate, magnesium carbonate, baking powder and/or cornstarch. It should be appreciated that appropriate ratios for these materials can be readily determine without resort to undue experimentation.

The carrier composition contained in the storage device 110 and the liquid animal scent composition contained in the storage device 112 are then supplied to a mixer 120 in a desirable ratio of about three parts carrier composition to about one part liquid animal scent composition. However, as outlined above, ratios from about 80%/20% carrier composition to liquid animal scent composition to about 70%/30% carrier composition to liquid animal scent composition can be used. Additionally, as outlined above, other ratios that result in a generally wetted to substantially a saturated carrier composition/liquid animal scent composition mixture can also be used. The carrier composition and the animal scent composition are thoroughly mixed together in the mixer 120 and the resulting paste-like mixture is placed into a dryer 130. In various exemplary embodiments, the resulting mixture is first placed into various trays 122, which are then placed into the dryer 130. In various other exemplary embodiments, the mixture is supplied to a continuous-feed dryer.

Once the resulting mixture is appropriately dried, for example by being dried as outlined above with respect to FIG. 1, the resulting dried mixture is introduced into a mill 140 where it is broken up into pieces ranging from dust-sized to small pebble-sized. Once the resulting dried mixture is broken up into such small pieces by the mill 140, the small pieces are feed into a sifter/screener 150. As shown in FIG. 2, the resulting pieces can be feed from the mill 140 to the sifter/screener 150 using a vibrating feeder 142. Of course, if the dryer 130 outputs the dried mixture in a powdered form or a near-powdered form, the mill 140 can be omitted and the dried mixture can be fed directly from the dryer 130 to the sifter/screener 150.

The sifter/screener 150 separates the usable fine powdered animal scent composition-sized particles output from the mill 140 from the larger particles which are not yet usable as the fine powdered animal scent composition according to this invention. In various exemplary embodiments, the sifter/screener 150 further breaks down such larger pieces into particles usable as the fine powdered animal scent composition according to this invention. The fine powdered animal scent composition particles separated by the sifter/screener 150 are fed into a collection drum 160. It should be appreciated that, in various exemplary embodiments, when milling and/or sifting the fine powdered animal scent composition according to this invention, the desired particle size for the fine powdered animal scent composition collected in the collection drum 160 should be on the order of the size of the particles of the original constituents of the carrier composition before being combined with the liquid animal scent composition. The other, larger-sized particles can be fed back into the mill 140 or can be further broken down by the sifter/screener 150, depending upon the capabilities of the sifter/screener 150. Once a desired quantity of fine powdered animal scent composition according to this invention is collection in the collection drum 160, the fine powdered animal scent composition can be introduced from the collection drum 160 into suitable packaging, such as the bottles, containers or the like outlined above.

### EXAMPLE

An exemplary animal scent composition according to this invention was manufactured using a Hobart® 30-quart industrial mixer with several mixing attachments, a Batch tray dryer having a caster-mounted cabinet with two doors, a Buffalo® hammermill; model w-6-L, an Eriez® model 20a; style 26 vibrating feeder with hopper and a Midwestern® single screen, 100 mesh, porta sifter screener.

The dryer has a cabinet that is 51″ wide across the front×70.5″tall×40″ deep, with internal dimensions of 43″ wide×30.5 deep×42″ high, for a capacity of approximately 32 cubic feet. The dryer has 32 aluminum trays that are 0.090″ thick, 15″ wide×30″ long×1.5″ deep. The dryer cabinet has 4″ of insulation in the housing, a 3 hp motor and a fan that circulates 1200 cfm of air internally. A heater block in the drying oven has four 1.75 kw incoloy heaters for a total of 7 kw. The temperature inside of drying oven is designed to maintained at up to 400 F, ±3 F. The dryer includes a desiccant dehumidifier, and sweeps 50 cfin of dry air through the dryer to remove the volatiles in a closed loop configuration.

The Buffalo® Hammermill includes two rows of 5 hammers each and two rows of 6 hammers each, where each hammer is 1.5″ wide×3.0″ long×¼″thick. A perforated plate is located in the bottom of the hammermill and has ¾″ to 1″ round holes. The hammermill has a 6″×6″ feed inlet and a 12″×6″ outlet. motors are 1 hp, 1735 rpm, 230/460, belt drive. carbon steel. The Eriez® hopper is a 4″×20″ vibrating feeder with hopper. The hopper is 13″ wide×13″ deep×9″ straight side×12″ long cone. The Midwestern® porta sifter screener is a single screen machine having a #100 mesh; a 4″ inlet in a top cover; a 4″ outlet in a bottom surface and is designed to fit on top of a drum.

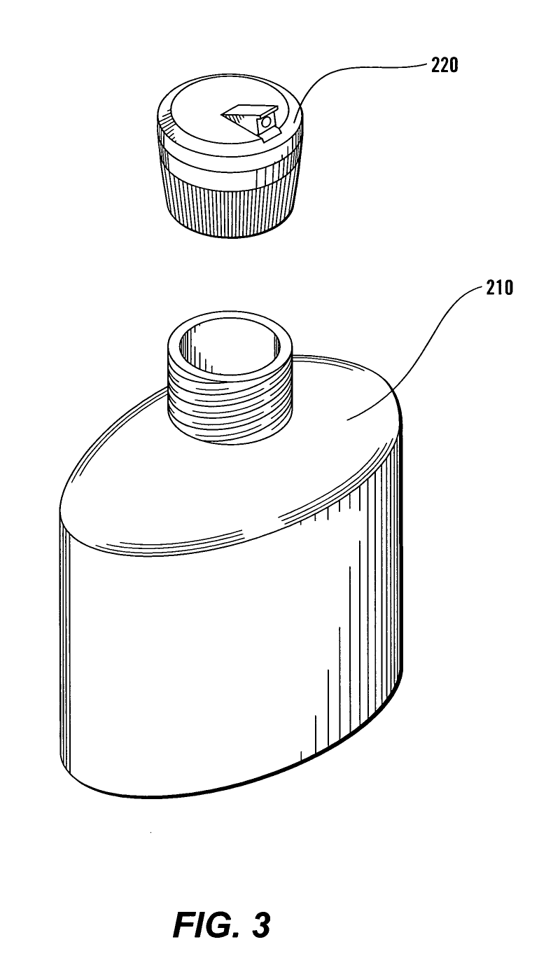

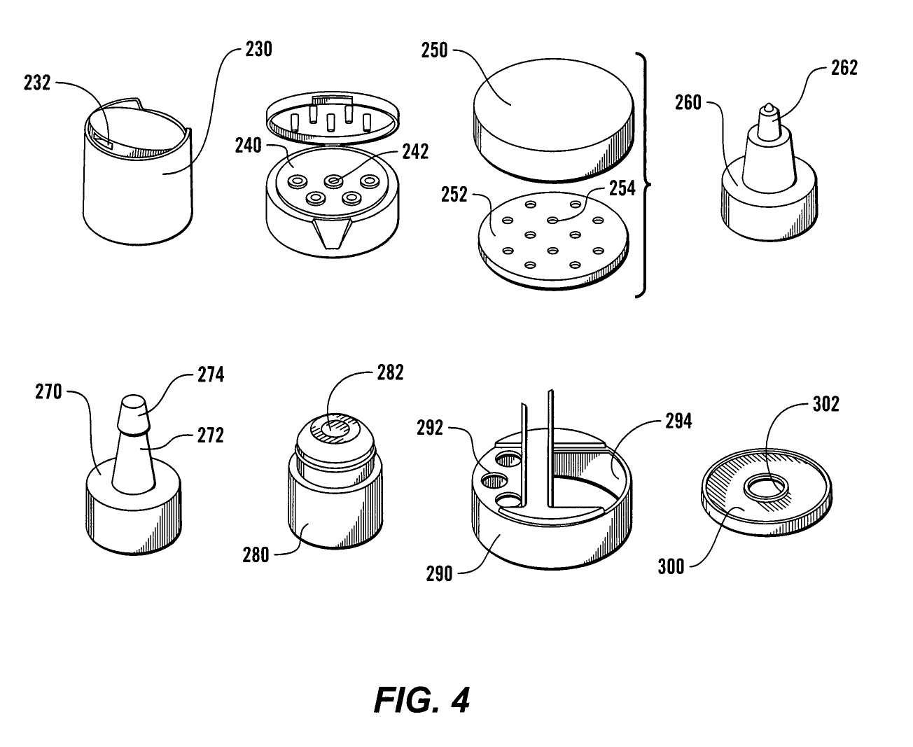

FIG. 3 shows one exemplary embodiment of an appropriate flexible container 210 and a suitable cap 220 that is usable to create a suspension or aerosol of the fine powdered animal scent composition according to this invention. FIG. 4 shows various exemplary embodiments of other suitable cap structures which can be used as or in place of the cap 220 on the container 210 shown in FIG. 3. As shown in FIG. 4, the various types of caps that could be used with the flexible package include a disk-style flip top cap 230 having a nozzle 232, a sifter cap 240 having a plurality of nozzles 242, a powder spice cap 250 with a sifter-style insert 252 that has a number of openings 254, a twist-to-open cap 260 having a nozzle 262, a spout cap 270 having a nozzle 272 and a cover 274, a push-pull cap 280 having a nozzle 282, a spice cap 290 having a number of integral sifter openings 292 and a flapper-type opening 294, and an orifice insert 300 that is inserted into a neck of a bottle or the like and that has an opening 302.

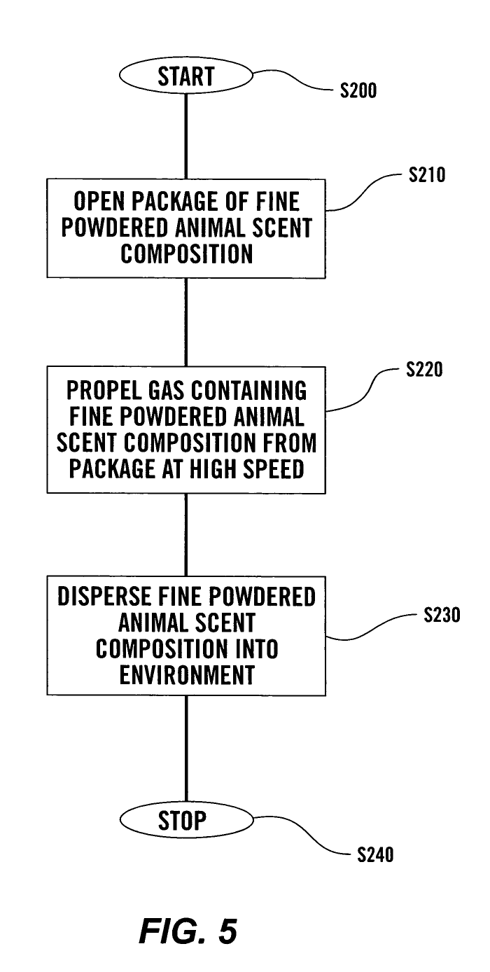

FIG. 5 is a flowchart outlining one exemplary embodiment of a method for using the fine powdered animal scent composition according to this invention. As shown in FIG. 5, beginning in step S200, operation of the method continues to step S210, where the container of the fine powdered animal scent composition is opened to allow the fine powdered animal scent composition according to this invention to be removed from the container. Next, in step S220, a gas containing the fine powdered animal scent composition is expelled from the container, for example, at high speed, to create an aerosol or suspension of the fine powdered animal scent composition in the atmosphere near the container. Then, in step S230, the fine powdered animal scent composition contained in the expelled gas is dispersed into the environment. Operation then continues to step S240.

It should be appreciated that, instead of ejecting the aerosol of the fine powdered animal scent composition generally into the ambient atmosphere, the aerosol can be ejected generally onto a deer scrape or the like, onto a person's body, onto a trail or the like, or onto plant stems, trunks, branches, leaves or the like. Because the fine powdered animal scent composition is ejected as an aerosol when directed onto such elements, the fine powdered animal scent composition will wet, cover, settle onto, or the like, that element in a generally even manner. Thus, in various exemplary embodiments, the fine powdered animal scent composition will be more efficiently and effectively dispersed onto such elements.

In step S240, the particles of the fine powdered animal scent composition in the aerosol or suspension expelled from the container in step S220 readily release scent compounds, molecules or the like into the environment to create a desired aroma that is readily detectable by the desired animal, i.e., is or becomes activated. In various exemplary embodiments, it is believed that the fine powdered animal scent composition reacts with moisture and/or heat in the ambient environment to readily release animal scent molecules and/or compounds from the carrier composition into the ambient environment. It should also be appreciated that, before performing step S2 10 or step S220, the container containing the fine powdered animal scent composition can be shaken to create fiction-induced heating and/or other physical effects that cause the fine powdered animal scent composition to more readily release animal scent molecules and/or compounds into the ambient environment. Operation then continues to step S250, where the method stops.

It should be appreciated that, once the fine powdered animal scent composition is introduced into the ambient environment as an aerosol or suspension, the fine powdered animal scent composition will tend to remain suspended in the ambient atmosphere, where it can be moved by air currents toward an animal to be lured to the dispersal point of the fine powdered animal scent composition. It is believed that, because of the structure of the fine powdered animal scent composition, the animal scent material will tend to be released from the carrier composition by ambient moisture and/or solar heating.

When the fine powdered animal scent composition is ejected into the air as an aerosol, air currents will tend to disperse the aerosol fine powdered animal scent composition creating an airborne scent trail that an animal to be lured to the desired location can follow. When the fine powdered animal scent composition is ejected onto plant stems, trunks, branches, leaves and the like, the body or clothing of a person, onto buck scrapes, trails or the like, aroma compounds and/or molecules released by the fine powdered animal scent composition will tend to lure the desired animal toward that location.

In various exemplary embodiments, the fine powdered animal scent composition according to this invention is able to release a sufficiently strong scent that it is able to mask or cover up the human scent of the person releasing the fine powdered animal scent composition into the environment. Thus, the fine powdered animal scent composition can be used as a “mask” or a “cover”, thus preventing the animal to be lured to the desired location from detecting the presence of one or more humans at the desired location.

It should also be appreciated that, in various exemplary embodiments of the fine powdered animal scent composition according to this invention, sufficient animal scent molecules and/or compounds are released from the carrier composition for up to 10 to 12 hours after the fine powdered animal scent composition is expelled into the ambient environment. At the same time, in various exemplary embodiments, after 20 to 24 hours after the fine powdered animal scent composition was expelled, it is no longer effective. Thus, a second application of the fine powdered animal scent composition can be made on consecutive days at different locations without confusing the animal to be lured to the new dispersal point.

While this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications variations, improvements, and/or substantial equivalents.

1. A fine powdered animal scent composition, comprising:
sodium bicarbonate;
silicon dioxide; and
an animal scent composition;
where the sodium bicarbonate, silicon dioxide, and animal scent composition are provided as a powdered mixture that can be ejected into an ambient atmosphere to form a suspension or aerosol of the fine powdered animal scent composition.

2. The fine powdered animal scent composition of claim 1, wherein:
the sodium bicarbonate and silicon dioxide are combined to form a first composition; and
fine powdered animal scent composition is formed by initially combining the first composition and the animal scent composition, in liquid form, at ratios between about 80%/20% to about 70%/30% by weight.

3. The fine powdered animal scent composition of claim 2, wherein the fine powdered liquid animal scent composition is formed by initially combining the first composition and the animal scent composition at a ratio of about 75% first composition to about 25% animal scent composition by weight.

4. The fine powdered animal scent composition of claim 2, wherein the first composition comprises:
about 95% to about 99% sodium bicarbonate by weight; and
about 1% to about 5% silicon dioxide by weight.

5. The fine powdered animal scent composition of claim 1, wherein:
the sodium bicarbonate and silicon dioxide are combined to form a first composition; and
fine powdered animal scent composition is formed by initially combining an amount of the first composition and an amount of the animal scent composition such that the amount of the animal scent composition at least completely wets the amount of the first composition.

6. The fine powdered animal scent composition of claim 1, wherein:
the sodium bicarbonate and silicon dioxide are combined to form a first composition; and
fine powdered animal scent composition is formed by initially combining an amount of the first composition and an amount of the animal scent composition such that the amount of the animal scent composition at most saturates the amount of the first composition.

7. A fine powdered animal scent composition formed by combining, by weight:
about 70% to about 80% of a carrier composition; and
about 20% to about 30% of a liquid animal scent composition.

8. The fine powdered animal scent composition of claim 7, wherein the fine powdered animal scent composition is formed by combining, by weight:
about 75% of the carrier composition; and
about 25% of the liquid animal scent composition.

9. The fine powdered animal scent composition of claim 7, wherein the fine powdered animal scent composition is formed by combining an amount of the carrier composition and an amount of the liquid animal scent composition such that the amount of the animal scent composition at least completely wets the amount of the carrier composition.

10. The fine powdered animal scent composition of claim 7, wherein the fine powdered animal scent composition is formed by combining an amount of the carrier composition and an amount of the liquid animal scent composition such that the amount of the animal scent composition at most saturates the amount of the carrier composition.

11. The fine powdered animal scent composition of claim 7, wherein the carrier composition comprises, by weight:
about 95% to about 99% sodium bicarbonate; and
about 1% to about 5% silicon dioxide.

12. The fine powdered animal scent composition of claim 7, wherein the carrier composition includes at least one of sodium bicarbonate, baking powder and cornstarch.

13. The fine powdered animal scent composition of claim 12, wherein the carrier composition further includes at least one of calcium carbonate and magnesium carbonate.

14. The fine powdered animal scent composition of claim 7, wherein the fine powdered animal scent composition, when ejected into the ambient atmosphere from a container containing the fine powdered animal scent composition, forms an aerosol or suspension in the ambient atmosphere.

15. A fine powdered animal scent composition manufactured by:
mixing together a carrier composition and a liquid animal scent composition;
drying the mixture of the carrier and liquid animal scent compositions;
breaking the dried mixture into at most small pieces;
separating fine particles of the mixture from the broken up dried mixture to collect the fine powdered animal scent composition.

16. The fine powdered animal scent composition of claim 15, wherein mixing together the carrier composition and the liquid animal scent composition comprises:
combining the carrier composition and the liquid animal scent composition at ratios between about 80%/20% to about 70%/30% by weight; and
mixing the carrier composition and the liquid animal scent composition to cause the carrier composition to absorb the liquid animal scent composition.

17. The fine powdered animal scent composition of claim 16, wherein combining the carrier composition and the liquid animal scent composition at ratios between about 80%/20% to about 70%/30% by weight comprises:
combining about 75% carrier composition by weight with about 25% liquid animal scent composition by weight.

18. The fine powdered animal scent composition of claim 15, wherein mixing together the carrier composition and the liquid animal scent composition comprises:
combining an amount of the carrier composition and an amount of the liquid animal scent composition such that the amount of the animal scent composition at least completely wets the amount of the carrier composition.

19. The fine powdered animal scent composition of claim 15, wherein mixing together the carrier composition and the liquid animal scent composition comprises:
combining an amount of the carrier composition and an amount of the liquid animal scent composition such that the amount of the animal scent composition at most saturates the amount of the carrier composition.

20. The fine powdered animal scent composition of claim 15, further comprising combining sodium bicarbonate and silicon dioxide to form the carrier composition.

21. The fine powdered animal scent composition of claim 20, wherein combining the sodium bicarbonate and silicon dioxide to form the carrier composition comprises:
combining about 95% to about 99% sodium bicarbonate by weight with about 1% to about 5% silicon dioxide by weight.

22. A method for manufacturing a fine powdered animal scent composition, comprising:
combining a dry carrier composition and a liquid animal scent composition;
mixing the combined dry carrier composition and the liquid animal scented composition;
drying the mixture;
separating fine powder particles of the dried mixture from other pieces of the dried mixture; and
collecting the separated fine powder particles to form the fine powdered animal scent composition.

23. The method of claim 22, further comprising placing the fine powdered animal scent composition into a container that allows the fine powdered animal scent composition to be expelled from the container as an aerosol or suspension into the ambient atmosphere.

24. The method of claim 22, wherein combining the dry carrier composition and the liquid animal scent composition comprises combining the dry carrier composition and the liquid animal scent composition at ratios between about 80%/20% to about 70%/30% by weight.

25. The fine powdered animal scent composition of claim 24, wherein combining the dry carrier composition and the liquid animal scent composition at ratios between about 80%/20% to about 70%/30% by weight comprises:
combining about 75% dry carrier composition by weight with about 25% liquid animal scent composition by weight.

26. The method of claim 22, wherein combining the dry carrier composition and the liquid animal scent composition comprises combining about three parts of the dry carrier composition with about one part of the liquid animal scent composition.

27. The method of claim 22, wherein combining the dry carrier composition and the liquid animal scented composition comprises:
combining an amount of the dry carrier composition and an amount of the liquid animal scent composition such that the amount of the animal scent composition at least completely wets the amount of the carrier composition.

28. The method of claim 22, wherein combining the dry carrier composition and the liquid animal scented composition comprises:
combining an amount of the dry carrier composition and an amount of the liquid animal scent composition such that the amount of the animal scent composition at most saturates the amount of the carrier composition.

29. The method of claim 22, further comprising combining about 95% to 99% sodium bicarbonate and about 1% to about 5% silicon dioxide to form the dry carrier composition.

30. The method of claim 22, further comprising combining at least one of sodium bicarbonate, baking powder and cornstarch with at least one of calcium carbonate and magnesium carbonate, and silicon dioxide to form the dry carrier composition.

31. The method of claim 22, further comprising breaking the dried mixture into small pieces before separating the fine powder particles of the dried mixture from other pieces of the dried mixture.

32. A method for forming a fine powdered animal scent composition, comprising:
mixing together a carrier composition and a liquid animal scent composition;
drying the mixture of the carrier and liquid animal scent compositions;
separating fine particles of the mixture from the remaining portion of the dried mixture to collect the fine powdered animal scent composition.

33. The method of claim 32, wherein mixing together the carrier composition and the liquid animal scent composition comprises:
combining the carrier composition and the liquid animal scent composition at ratios between about 80%/20% to about 70%/30% by weight; and
mixing the carrier composition and the liquid animal scent composition to cause the carrier composition to absorb the liquid animal scent composition.

34. The method of claim 33, wherein combining the carrier composition and the liquid animal scent composition at ratios between about 80%/20% to about 70%/30% by weight comprises:
combining about 75% carrier composition by weight with about 25% liquid animal scent composition by weight.

35. The method of claim 32, wherein mixing together the carrier composition and the liquid animal scent composition comprises:
combining about three parts of the carrier composition with about one part of the liquid animal scent composition; and
mixing the carrier composition and the liquid animal scent composition to cause the carrier composition to absorb the liquid animal scent composition.

36. The method of claim 32, wherein mixing together the carrier composition and the liquid animal scented composition comprises:
combining an amount of the carrier composition and an amount of the liquid animal scent composition such that the amount of the animal scent composition is able to at least completely wet the amount of the carrier composition; and
mixing the carrier composition and the liquid animal scent composition to cause the carrier composition to absorb the liquid animal scent composition.

37. The method of claim 32, wherein mixing together the carrier composition and the liquid animal scented composition comprises:
combining an amount of the carrier composition and an amount of the liquid animal scent composition such that the amount of the animal scent composition is able to at most saturate the amount of the carrier composition; and
mixing the carrier composition and the liquid animal scent composition to cause the carrier composition to absorb the liquid animal scent composition.

38. The method of claim 32, further comprising combining sodium bicarbonate and silicon dioxide to form the carrier composition.

39. The method of claim 38, wherein combining the sodium bicarbonate and silicon dioxide to form the carrier composition comprises:
combining about 95% to about 99% sodium bicarbonate by weight with about 1% to about 5% silicon dioxide by weight.

40. The method of claim 32, further comprising breaking the dried mixture into small pieces before separating the fine powder particles of the dried mixture from other pieces of the dried mixture.

41. The method of claim 32, further comprising placing the fine powdered animal scent composition into a container that allows the fine powdered animal scent composition to be expelled from the container as an aerosol or suspension into the ambient atmosphere.
